(19) United States
(12) Patent Application Publication
(10) Pub. No.: US 2004/0048623 A1
(43) Pub. Date: Mar. 11, 2004

(54) Burst communications system and method

(76) Inventor: James P. Flannery, Nyack, NY (US)

Correspondence Address: Reveo, Inc., 85 Executive Blvd., Elmsford, NY, 10523, US

(21) Appl. No.: 10/464,841

(22) Filed: Jun. 18, 2003

Related U.S. Application Data
(60) Provisional application No. 60/389,821, filed on Jun. 18, 2002.

(51) Int. Cl. G01S 3/02

(52) U.S. Cl. 455/456.6; 455/404.2; 455/456.2; 455/456.1; 342/462

(57) ABSTRACT

A communication method and system for transmitting a real data signals is provided. In one aspect, the location of a communications device is determined. At least two transmitter/receiver devices are provided. A first data signal is transmitted from the communications device to the at least two transmitter/receiver devices. The data signal is received only by both receivers in combination, and with the knowledge of the location of the communication device, time delays associated with the position of the communications device are accounted for. Alternatively, a portion of a signal is sent from each of the at least two transmitter/receiver devices to the communications device, and are combined at the communications device, whereby knowledge of the location of the communication device allows time delays associated with the position of the communications device to be accounted for. In another aspect of the present invention, a communications method and system are provided for transmitting a real data signal including a communications device and a transmitter device or a receiving device. A first data signal is transmitted from the communications device to the receiving device, or a second signal is transmitted from the transmitter device to the communications device. The first or second data signals are entirely comprised of, or at least include as representation of part of the real data, signal characteristics, such as a time slot within a time period, frequency, or amplitude. The signal characteristic(s) are representative of at least a portion of the real data signal. In still a further aspect, a system may combine a divided signal as described with respect to the first aspect of the invention, whereby one or more of the signal portions are signal characteristic(s) are representative of at least a portion of the real data signal.

### RELATED APPLICATIONS

The present invention claims priority to U.S. Provisional Patent Application No. 60/389,821 filed Jun. 18, 2002 entitled “Temporal-And Spatial-Dependent Burst Communications”.

### BACKGROUND

1. Field of the Invention

The present invention relates to communication methods and systems, and particularly burst communication methods and systems have the ability to enhance data transmission density, increase security of transmissions and reduce power demands on communication devices.

2. Description of the Prior Art

The field of wireless communications has been pushed forward in recent years by the introduction of burst communications. This technology holds significant promise for developing secure systems for the transmission of large amounts of data. The current mainstream systems and methods for wireless communication are based upon data being embedded into a carrier wave signal. However, such systems require presence of the carrier wave signal and an embedded or corresponding data signal substantially continuously.

Certain systems that rely on burst communications do not require a carrier wave in order to transmit data. A benefit on not having a carrier wave in burst communications is that multiple frequencies can be used. That is, data can be sent in very small packets across a broad spectrum of frequencies. This type of communication is referred to as ultra-wideband (UWB) radio communication.

One currently available UWB technology is 802.11b (WiFi) wireless network communication protocol. This method of burst communications relies upon establishing and maintaining active connections. Each communicating device is given a static frequency on which to communicate for a given period of time. However, the 802.11b standard, and related wireless network protocols, are generally limited in terms of the distance that the signal can travel.

Other burst communication protocols, such as the protocol used by Blackberry® devices, are suitable for their intended purposes, however, high data density transmission is not capable by such protocols.

There remains a need for a burst communications method and system that is capable of improved data communication (i.e., increased data density), low power consumption, and high security.

### SUMMARY OF THE INVENTION

In one aspect, the present invention includes a communication method and system for transmitting a real data signal including determining the location of a communications device. At least two transmitter/receiver devices are provided in this aspect of the invention. A first data signal is transmitted from the communications device to the at least two transmitter/receiver devices. The data signal is received only by both receivers in combination, and with the knowledge of the location of the communication device, time delays associated with the position of the communications device are accounted for. In another embodiment, a portion of a signal is sent from each of the at least two transmitter/receiver devices to the communications device, and are combined at the communications device, whereby knowledge of the location of the communication device allows time delays associated with the position of the communications device to be accounted for.

In another aspect of the present invention, a communications method and system are provided for transmitting a real data signal including a communications device and a transmitter device or a receiving device. A first data signal is transmitted from the communications device to the receiving device, or a second signal is transmitted from the transmitter device to the communications device. The first or second data signals are entirely comprised of, or at least include as representation of part of the real data, signal characteristics, such as a time slot within a time period, frequency, or amplitude. The signal characteristic(s) are representative of at least a portion of the real data signal.

In still a further aspect, a system may combine a divided signal as described with respect to the first aspect of the invention, whereby one or more of the signal portions are signal characteristic(s) are representative of at least a portion of the real data signal.

The above-discussed and other features and advantages of the present invention will be appreciated and understood by those skilled in the art from the following detailed description and drawings.

### BRIEF DESCRIPTION OF THE DRAWINGS

FIG. 1 represents one aspect of the present invention utilizing plural transmitters/receivers associated with each communication device;

FIG. 2 is a flow chart outlining the general steps another aspect of the present invention;

FIG. 3 is an exemplary table of time and frequency slots having binary bit values;

FIGS. 4 and 5 represent encoding and decoding, respectively, of the signal characteristic data used to represent real data; and

FIG. 6 represents an embodiment of the present invention utilizing optical signals in a free space environment.

### DETAILED DESCRIPTION OF THE INVENTION

As used herein, “communication device” refers to a device capable of transmitting, receiving, or both transmitting and receiving data. For example, such a communication device may be used by an individual, such as mobile telephones or two-way radios, personal digital assistants, mobile e-mail devices (e.g., similar to the Blackberry® device), video transmitters and/or receivers, devices embedded in automobiles, railcars, aircraft, watercraft, or other transportation systems, or the like. Further, such a communication device may be used by a unmanned data transmitters and/or receivers, such as property sensors (e.g., temperature, pressure, humidity, chemical concentration sensors, etc.), device health monitors, audio bugging devices, video transmitters and/or receivers, or the like.

“Receiving device(s)” refers to devices capable of receiving data from the communication device. Such receiving devices may be stationary (e.g., in the form of receiving towers or bases), or mobile (e.g., portable receivers or receivers included in land, sea or air transports).

“Transmitting device(s)” refers to devices capable of transmitting data to the communication device. Such transmitting devices may be stationary (e.g., in the form of receiving transmitting or bases), or mobile (e.g., portable transmitters or transmitters included in land, sea or air transports).

“Transmitting/receiving device(s)” include devices having functionality of both the receiving devices and the transmitting devices, either simultaneously or separately.

“Real data signal” refers to a data signal including but not limited to audio, video, text, or other data communicated between one or more communication devices and receiving devices and/or transmitting devices. Such signals, in certain embodiments, may be transmitted as analog signals; however, typically, the communicated signals are digital signals. The data signal in wireless transmission may be in mediums including, but not limited to, light, radio waves, sound waves, or any other signaling medium that can be adjusted in frequency. Further, in wired transmissions, the data signal may be in medium such as fiber optics or conventional network wires.

Spatial-Dependent Burst Communications Method and System

A communication protocol, and in certain embodiments a UWB communication protocol, is provided that is dependent upon learning the location of the communications devices through triangulation. This protocol is intrinsically different than other communication protocols in that it does not use a one-to-one communication paradigm.

Existing systems and methods for transmitting wireless and wired data are all based upon a one-to-one communication paradigm. When a conventional one-to-many paradigm is employed, the signal is redundantly read and understood by each receiving device. In networking terms, this is referred to as multi-casting—that is, transmitting from one communication device to many receiving devices.

Herein described is a unique protocol that necessitates receipt by multiple receiving devices in order for the signal to be read—that is, a one-to-many communications protocol where two or more receivers are required to correlate the received signal into a single message.

In another embodiment, a many-to-one communication protocol is provided employing transmission of a real data signal in separate portions from multiple transmission devices to a communication device.

In one embodiment, the method and system employs burst transmissions of data from a communications device to at least two receiving devices. The data is dissected into separate time components for burst transmission. Dissected portions of data and location data are sent from a transmission device to one of the at least two receiving devices. In certain preferred embodiments (e.g., wherein very secure transmission is a prime consideration), each dissected portion of real data and/or location data is transmitted to only one of the at least two receiving devices, and other dissected portions of real data and/or location data are transmitted to another receiving device. This method may transmit data substantially simultaneously to separate receivers or otherwise. The plural transmissions are assembled at one or more of the receiving devices, or at a separate device. The data assembly determines which transmitting device among a plurality of transmitting devices sent the data by comparing the location of the transmitting communicating device, or integrated spatial data, wherein the location of the particular transmitting device is determinable based on knowledge of location, and relative locations, of the receiving devices (stationary or mobile); and knowledge of the location of the transmission device (based the location data of the transmitting device), using, e.g., typical global positioning systems or triangulation techniques.

In another embodiment, the method and system employs burst transmissions of data from at least two transmission devices to a communications device. The data is dissected into separate components for burst transmission. Dissected portions of data and previously determined location data are sent from the plural receiving devices in separate time components to the communication device. The plural transmissions are assembled at the communication device.

Alternative methods of determining the location of the communication device at a given time are available. In certain methods of determining the location of the communication device at a given time, a handshake can be established between the communication device and the receiving and/or transmitting devices. In other methods of determining the location of the communication device at a given time, the location data can be sent by alternate means to the receiving and/or transmitting devices (e.g., data from global positioning systems). In still further methods of determining the location of the communication device at a given time, location data can be transmitted once, and subsequent updates are sent, for example in the form of a unique ping including location information. Still further methods of determining the location of the communication device at a given time may rely on laser communications between, e.g., a device (communication device, transmitter, receiver, and/or transmitter/receiver) and a system with known position, e.g., an orbiting satellite.

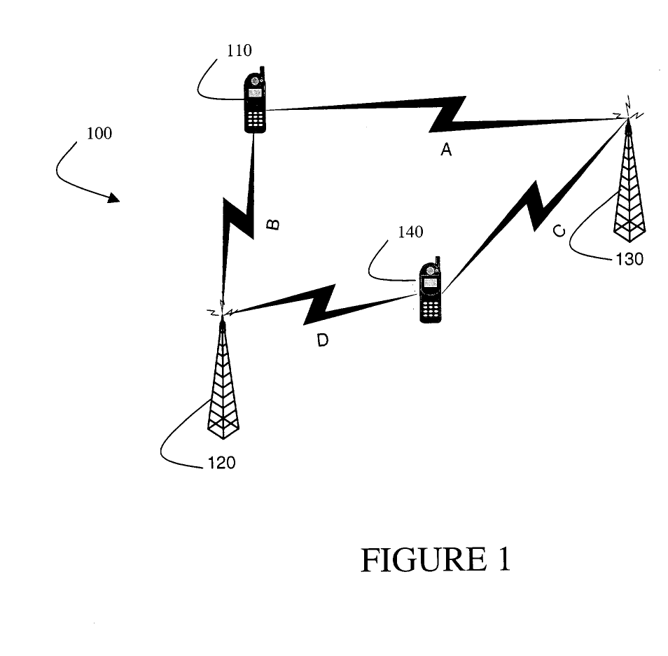

In additional methods of determining the location of the communication device at a given time, a unique ping signal is broadcasted that allows the receiving and/or transmitting devices to recognize the communication device and triangulate its position. As shown in FIG. 1, a system 100 includes a first communication device 110 and a second communication device 140. As shown in the example, first communication device 110 sends a signal in all directions that is received by a transmitter/receiver 120 after traveling distance B and by a transmitter/receiver 130 after traveling distance A. The broadcast signal can be triangulated based upon the time delay between the two transmitter/receivers 120,130 and the angle at which the signal was received. The accuracy of the time delay may be based on, e.g., the type of data and the type of communication devices, and may be on the order of seconds, deci-seconds, centi-seconds, milli-seconds, micro-seconds, nano-seconds, or sub-nano-seconds. By knowing the moment the signal was sent and triangulating the signal, the bits may be reassembled into a message. The triangulation and reassembly of the data can only work if both transmitter/receivers 120,130 can communicate with each other so they can exchange data based on what data was received, when the data was received, and in what sequence data is received from. Reception by multiple receivers and triangulation of the signal is necessary to distinguish the signal sent by communication device 110 from any signal sent by communication device 140.

Also as shown in FIG. 1, a message is to be received by communication device 110. Transmitter/receiver 130 sends a signal directly by communication device 110. Then transmitter/receiver 120 sends a delayed signal directly to communication device 110 that compensates for the extra physical distance that signal from transmitter/receiver 130 must to travel. Both directional signals arrive at communication device 10 at the same moment in time, within the proscribed accuracy level, indicating to the CD1 that it is a valid signal. It is necessary to receive a signal from multiple transmitters to distinguish that signal from any other signal sent by another communication device.

Once the location of all devices requesting communication is known, a communication device can send a signal directly to multiple transmitter/receivers as opposed to broadcasting in all directions. This makes it much more difficult to detect communication because it is directional toward the transmitter/receivers.

An advantage of the present method is that packet headers, commonly required for most current communication protocols, are not necessarily required to communicate. Time-space stamping and triangulation of the sending and receiving of data may be relied upon to accomplish the differentiation between the different communicating devices.

Communication protocols by their intrinsic nature divide up available resources (that is, bandwidth) among the communicating devices. The protocol described herein is different because it is not necessary to divide up resources such as frequencies and time slots to the communicating devices (although in certain embodiments it is possible). In the present invention, frequency and time slots may be negotiated using multiple concurrent rotating algorithms to switch frequencies and time tokens automatically without having any cancellation in the system. The protocol according to the present invention does not require the level of overhead in terms of maintaining a connection and negotiation available bandwidth that current protocols require.

In contrast to conventional communication protocols, the herein presented protocol differentiates between plural signals because the location of all the communication devices is used. In the exemplary embodiment, the system reassembles all the individual messages from the cacophony of radio traffic using triangulation. When multiple communication devices are sending information simultaneously, it is nearly impossible to distinguish individual communication devices unless the system “knows” where the individual communication devices are. This makes it exceptionally difficult for anyone attempting to intercept communications to recognize that a message is being sent, yet alone distinguish a single message from the static.

Further, since only signals paired based on spatial and temporal matching are capable of being combined, these signals may be embedded within “noise” comprising plural signals sent solely for the purpose of disguising the paired signals.

Communications Method and System Utilizing Signal Characteristics as Variables Representing Real Data

In another method and system for communications of the present invention, signal characteristics are selected so as to represent bit values corresponding to real data for transmission and receipt. The present invention is advantageous in that short packets, in some instances a single ping signal, contain signal characteristics that are indicative of the real data to be transmitted, thus the need for continuous or intermittent real data (or encrypted data) burst communications are obviated. Accordingly, very short transmissions may contain tremendous amounts of data.

In one embodiment, the signal characteristic is the time slot at which the ping signal is sent within a given time period. The time period may be any time period, depending on the need for updated data by the communication device(s), the desired security level, and other factors. For example, the time period may be based on a cycle characteristic of the signals. The time period may be on the order of seconds, deci-seconds, centi-seconds, milli-seconds, micro-seconds, nano-seconds, or sub-nano-seconds. In still further embodiments, where less frequent communication is required, the time period may be on the order of minutes, hours, days, weeks, months, etc. The period between individual time slots accordingly is less than the time period.

In certain embodiments, the time that the signal is received is itself indicative of the time slot. However, in such embodiments, the above described techniques for determining location at a give time (e.g., triangulation, GPS, or other methods of determining location at a give time) are required, as a correlation need be made between the time the signal is sent and the expected receipt time. Accordingly, if, e.g., it is desired to send a signal at an arbitrarily selected time slot t1, and the delay based on known location information is an absolute value t2, the signal should be sent at a time quantity t2 less than the time slot t1.

In other embodiments, the signal may incorporate time information, e.g., in the form of a header or a real data transmission indicating time sent, and the exact time that the signal is sent is irrelevant.

In another embodiment, the signal characteristic is the frequency of the signal itself. The range of frequencies available for a particular communications method and system depends on the protocol (e.g., RF signals, optical signals, sonic signals, fiber optic wire signals). The breadth of the spectrum of frequencies and the differential value between different frequencies each representative of a bit value will determine the number of discrete bit values that may be assigned. For example, in radio frequency based signals, as is known to those skilled in the art, ranges may be very low frequency (10-30 kilohertz), low frequency (30-300 kilohertz), medium frequency (300-3000 kilohertz), high frequency (3,000-30,000 kilohertz), very high frequency (30,000-300,000 kilohertz), ultra high frequency (300,000-3,000,000 kilohertz), super high frequency (3,000,000-30,000,000 kilohertz), or extremely high frequency (30,000,000-300,000,000 kilohertz).

Sonar signals may be any suitable frequency depending on the transmission media. For example, very low frequencies may be transmitted underwater or through the air. Further, in outer space, the present invention may utilize a wider range of sonic frequencies, and atmospheric interference is nonexistent.

Free space optical signal frequencies may depend on the distance between devices. Such signals may be in the form of optical signals, utilizing any suitable portion of the optical wavelength (frequency) spectrum. For example, gamma rays, x-rays, visible spectrum signals, or infrared rays may be used.

In another embodiment, the signal characteristic is the amplitude of the signal itself. Again, the amplitude range and differential amplitude values corresponding to discrete bit values depends on the type of communication protocol.

In still further embodiments, wherein the communication is based on fiber optics, the angle of incidence of the optical signal through the fiber optic wire is the signal characteristic used to represent bit values, as is known to those skilled in the art of wavelength division multiplexing.

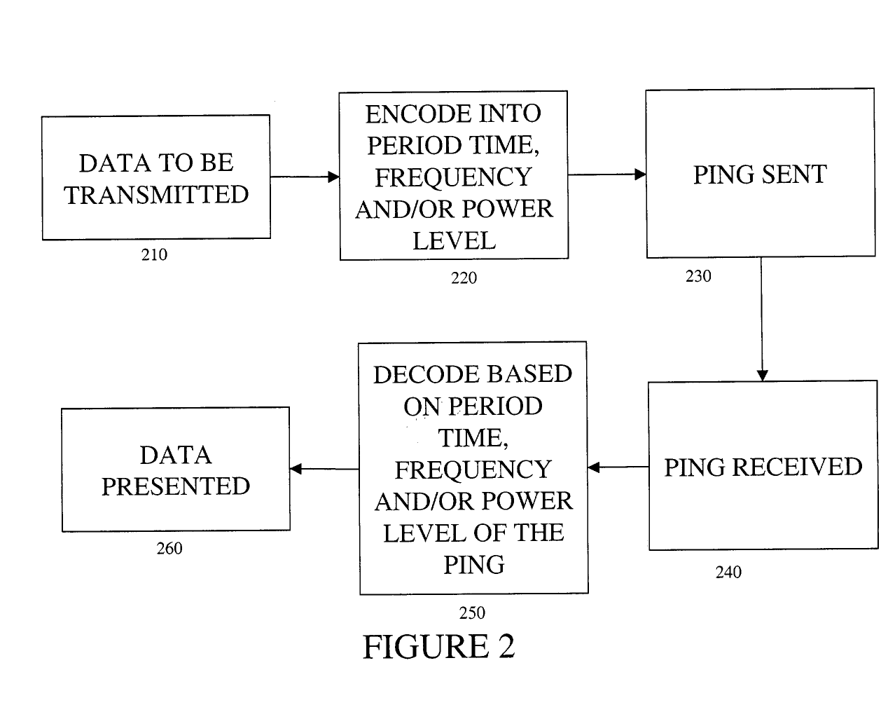

Referring now to FIG. 2, a block diagram indicating the steps for the herein communications method are shown. At block 210, data to be transmitted is determined, and sent to block 220. At block 220, the data from block 210 is encoded, with suitable encoding algorithms, into: a time slot within a time cycle period; a frequency value; and/or a power or amplitude level. Blocks 230 and 240 represent transmission and receipt of a ping signal having characteristic time slot within a time cycle period, frequency value, and/or amplitude level. At block 250, the ping is decoded based on the ping signal's requisite time slot within the time cycle period, frequency value, and/or amplitude level, using a decoding algorithm based on the algorithm used at block 220. The data is converted and presented (displayed or otherwise utilized, saved, etc.) at block 260.

In another embodiment of a data communications protocol, the intrinsic nature of burst communications is used to encode the data being sent. That is, a particular time within a given time period, a frequency, or a signal amplitude value all may be used, alone or in combination, as variables representing real data.

The instant methods and systems group time slots together into blocks of time slots and each individual time slot within that block is assigned a value. The protocol also assigns each individual frequency a value. Instead of transmitting raw data, the frequency and time slot when a signal is sent determines the value of the transmitted data. This has the effect of further reducing the amount of individual signals that must be sent in order to transmit a message. This increases difficulty of detecting if a signal is being transmitted because it takes less signals to transmit a message using this protocol.

An algorithm in the communication device and in the transmitter/receivers calculates the changing values that are assigned to individual time slots and individual frequencies. Each communication device may have different rotating values, making it extremely difficult to intercept a message, and basically impossible to determine the contents of that message without know the algorithm, the rotating frequency and the location of the communication device. In most cases the message itself will also be encrypted using, creating another layer of security on top of an already very secure system.

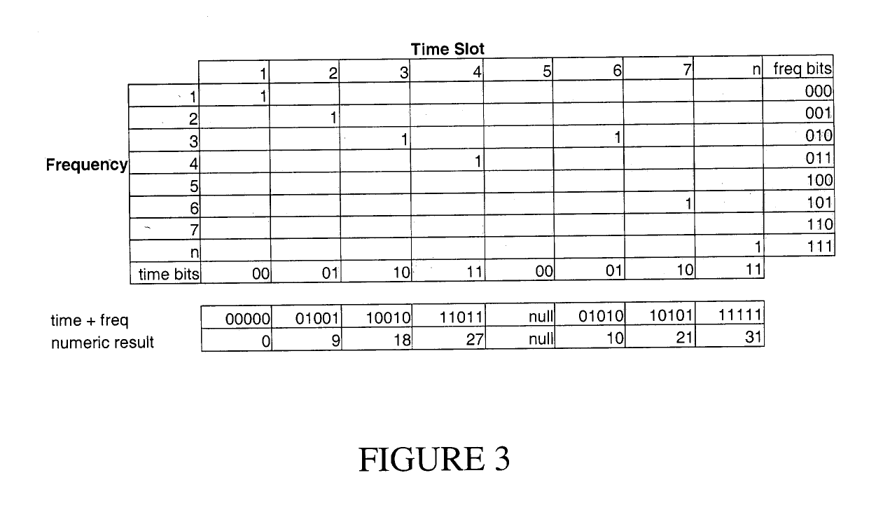

Referring now to FIG. 3, a table is provided depicting exemplary data embedded in the time slot and frequency of the transmitted signal. The frequency slot and time slot are each assigned a binary number value. In this example, there are 8 frequencies which each have a unique value. There are 4 time slots with unique value, hence the time slot values repeat every 4 time slots (i.e., the time period is 4 time slots). In this example, the binary numbers are assembled based upon taking the time slot value and placing it in front of the frequency value. However, it is understood that the assembly may be reversed or otherwise changed, depending on the algorithm used.

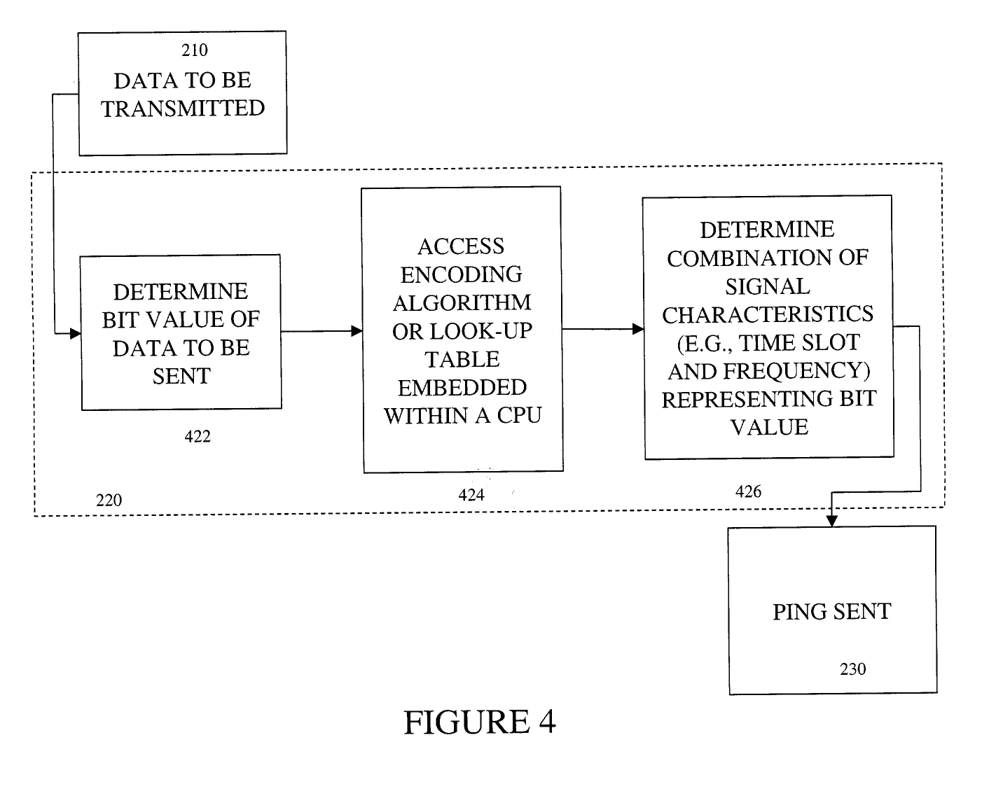

Furthermore, as represented in FIG. 4, the encoding of the bit value of the data to be sent may be based on certain combinations of time slot and frequency value. That is, the bit value of a particular time slot may be different for one frequency than the bit value of the same time slot for another frequency, and likewise, the bit value of a particular frequency may be different for one time slot than the bit value of the same frequency for another time slot. These values may be determined by a suitable algorithm, or a look-up table, embedded within, e.g., a suitable encoding/decoding device in the form of a chip or CPU within the communications devices and transmitters, receivers and/or transmitters/receivers of the system. As shown in FIG. 4, at block 210 (of FIG. 2) data to be transmitted is encoded by a system 220 including: conversion to a bit value represented at block 422; accessing an encoding algorithm or look-up table within a CPU of the transmitters or transmitters/receivers represented at block 424; determination of a combination of a time slot and frequency representing the bit value indicated at block 426. The time slot and frequency are used to send a ping signal as represented at block 230.

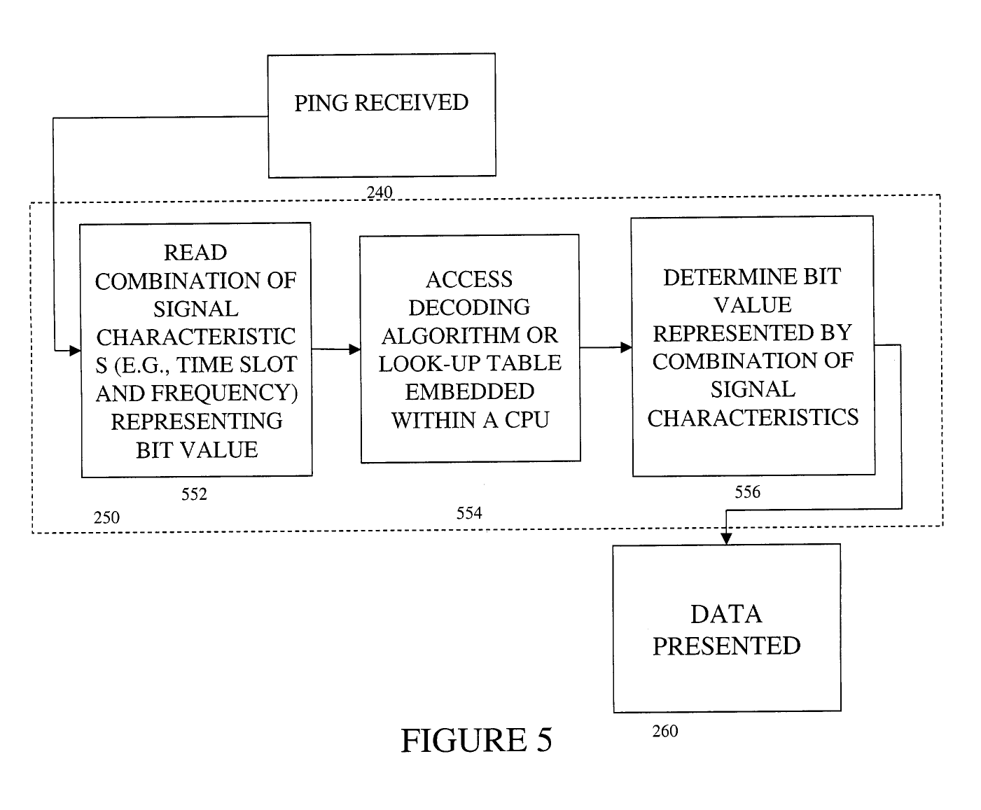

Referring now to FIG. 5, decoding at the communication device follows a similar scheme. At block 240, a ping signal if received and decoded by a system 250 including: reading a combination of signal characteristics (e.g., time slot and frequency, time slot and amplitude, frequency and amplitude, or any other combination) representing bit value represented at block 552; accessing a decoding algorithm or look-up table represented at block 554; and determining a bit value represented by the combination of signal characteristics using the decoding algorithm or look-up table represented at block 556.

It should be noted that for increased security, the encoding and decoding algorithms may periodically be modified.

Note that, for example, if 8 different time slots are allocated (2³ unique binary number values), 8 different frequencies are allocated (2³ unique binary number values), and 8 different amplitudes are allocated (2³ unique binary number values), a single ping signal may carry as much as 512 bits per ping signal. If the time period allows for a larger number of time slots (e.g., with higher precision spatial and temporal information), if 64 time slots are allocated, a single ping signal may carry as much as 4096 bits per ping signal. Of course, signal characteristics may be divided into any suitable number of slots to achieve greater data density. For example, if signals are sent once per hour, and the system is capable of milli-second time slots, 3,600,000 unique bit pattern slots may be provided in the time slot alone. In combination with 8 frequency slots and 8 amplitude slots, a single ping signal may carry as much as 230,400,000 bits per ping signal.

A primary benefit of such a system is that, due to the unique time/frequency data encoding protocol, high data density is possible. Further, size and power requirements for communications devices, particularly portable communication devices, may be substantially reduced compared to conventional communication devices using direct data transmission. Further, portable or stationary devices may benefit from a very small footprint. Additionally, since huge amounts of data may be sent with single ping signals, bandwidth is preserved.

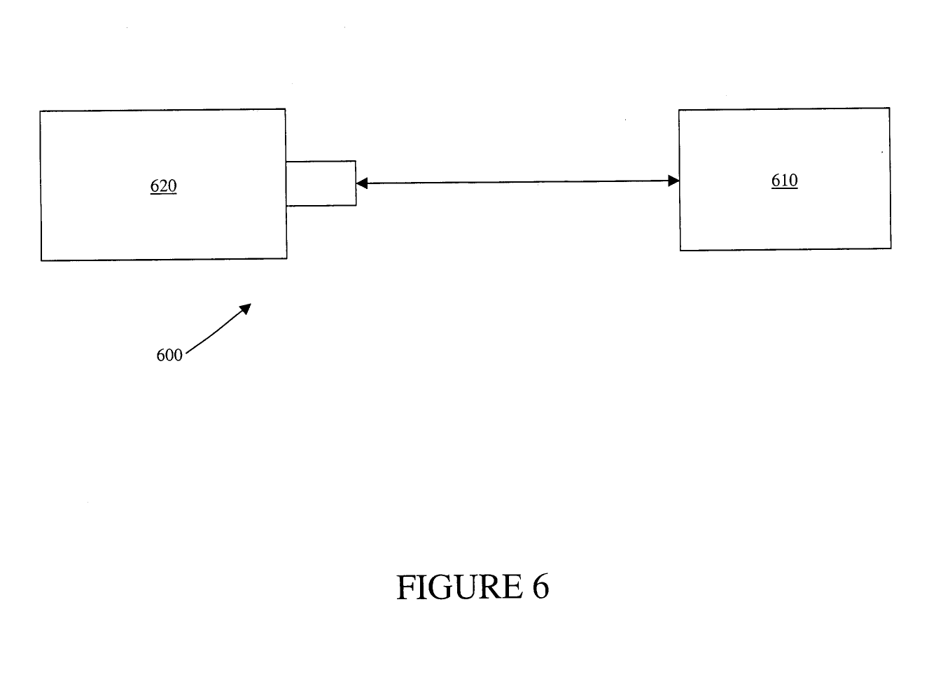

In another embodiment, and referring to FIG. 6, the frequency- and time-dependent data transmission communications protocol may be combined with other communication protocols, such as described in U.S. patent application Ser. No. 09/896,508 entitled “System And Method For Wavelength Modulated Free Space Optical Communication” filed on Jul. 18, 2000 and U.S. patent application Ser. No. 10/453,857 entitled “System and Method for Noise Suppression in Optical Communication” filed on Jun. 3, 2002, both of which are incorporated by reference herein. As shown in FIG. 6, a system 600, e.g., a free space optics system, includes a communications device 610 and a transmitter/receiver 620. The system operates in the same manner as described above, i.e., wherein the data signal is encoded such that signal characteristic data is used by the components as variables representing bit values.

Such combined systems may attain 1 petabit/second if 10M frequencies and 1/100 th of nanosecond bursts can be achieved. These calculations assume that only a single bit is sent. That is, the bit is either sent or it isn't. If a bit can be encoded to send more than one type of bit, then additional information can be embedded in those bits. For example if instead of one type of bit there were 4 types of bits, then you could encode 4 times as much data (as shown below implementing time slots and frequency slots as signal characteristics).

| | | |
|---|---|---|
| Number of Frequencies | 10,000,000 | |
| Time Slots per Cycle | 100 | |
| Total Bits per Cycle | 1,000,000,000 | |
| Slot Size (seconds) | 0.00000001 | 1/100 of a nanosecond |
| Cycles per Second | 1,000,000 | |
| Total Bandwidth | 1,000,000,000,000,000 | bits/sec |

Another method to embed additional data using an algorithm is provided. Additional data may be embedded into the data transmission by allowing for more than one bit to be sent during a single cycle if certain rules apply.

For example, assume 100 time slots per cycle and each is assigned a number from 1 to 100. If a random value occurs in the cycle, there is a basically 50% chance that the next value will be greater than that value. If the value is greater, then there is no need to wait for the cycle to end and second bit can be sent in the same cycle. It should be possible to embed multiple bits into a single cycle if they following sequentially. The present system should be able to embed 50% more data into the data transmission—that is, 1.5 petabits/second.

Communications Method and System Utilizing Signal Characteristics as Variables Representing Real Data in Combination with the Location of the Communication Device at a Given Time

In a further embodiment, a unique protocol includes a combination of both signal characteristics as variables representing real data and locational information of the communication data at a give time. That is, the protocol requires receipt by multiple receiving devices for the signal to be differentiated based on triangulation, and the signal characteristics of the signal(s) sent determines the value of the transmitted data.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A communication system for transmitting a real data signal comprising:
location determining system for determining location of a communications device relative to at least two transmitter/receiver devices;
wherein a first data signal is transmitted from the communications device to the at least two transmitter/receiver devices,
wherein the first data signal is partitioned into a number of components corresponding to the number of transmitter/receiver devices;
wherein the components are sent individually to each transmitter/receiver device, at least one of the components sent with a time delay equal to a time difference based on relative location differences between the communications device and each of the at least two transmitter/receiver devices.

2. A communication system for transmitting a real data signal comprising:
location determining system for determining location of a communications device relative to at least two transmitter/receiver devices;
wherein a plurality of data signals corresponding to the number transmitter/receiver devices are transmitted from the at least two transmitter/receiver devices to the communications device,
wherein each of the plurality of data signals are sent individually to the communications device, at least one of the data signals sent with a time delay equal to a time difference based on relative location differences between the communications device and each of the at least two transmitter/receiver devices.

3. A communication system for transmitting a real data signal comprising:
a communications device;
a transmitter device or a receiving device;
wherein a first data signal is transmitted from the communications device to the receiving device, or a second signal is transmitted from the transmitter device to the communications device,
wherein the first or second data signals comprise a signal characteristic that is indicative of at least a portion of the real data signal.

4. The communication system as in claim 3, wherein the signal characteristic is selected from the group consisting of a time slot within a time period, a frequency slot, an amplitude slot, or any combination comprising at least one of the foregoing signal characteristics.

5. The communication system as in claim 1, wherein the signal is radio.

6. The communication system as in claim 1, wherein the signal is optical.

7. The communication system as in claim 6, wherein the optical signal is free space optics or fiber optics.

8. The communication system as in claim 1, wherein the signal is sonic.

9. The communication system as in claim 2, wherein the signal is radio.

10. The communication system as in claim 2, wherein the signal is optical.

11. The communication system as in claim 10, wherein the optical signal is free space optics or fiber optics.

12. The communication system as in claim 2, wherein the signal is sonic.

13. The communication system as in claim 3, wherein the signal is radio.

14. The communication system as in claim 3, wherein the signal is optical.

15. The communication system as in claim 14, wherein the optical signal is free space optics.

16. The communication system as in claim 14, wherein the optical signal is fiber optics.

17. The communication system as in claim 16, wherein the signal characteristic is selected from the group consisting of a time slot within a time period, a frequency slot, an amplitude slot, an angle of incidence, or any combination comprising at least one of the foregoing signal characteristics.

18. The communication system as in claim 3, wherein the signal is sonic.
